(19) United States
(12) Patent Application Publication
(10) Pub. No.: US 2008/0034030 A1
(43) Pub. Date: Feb. 7, 2008

(54) PROVIDING PREDICTIVE RESULTS BASED UPON REAL TIME DATA FEEDS FROM MULTIPLE PARTIES

(75) Inventor: JAMES J. TOOHEY, BOCA RATON, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/462,761

(22) Filed: Aug. 7, 2006

(51) Int. Cl. G06F 15/16; G06F 15/173

(52) U.S. Cl. 709/203; 709/223

(57) ABSTRACT

The present invention cain include a method for providing a real time information service. The method can receive real time data feeds from remotely located data sources. Data from one or more static data feeds can optionally be combined with the real time data. Data elements from the feeds can be input into at least one predictive application. Predictive results can be generated by the predictive application. An information dispatch can be generated from the predictive results. The dispatch can be conveyed to a remotely located information consumer before events that are indicated by the predictive results occur. As the real time data from the data feeds changes, additional dispatches can be automatically convey,ed to the information consumer in a timely fashion.

### FIELD OF THE INVENTION

The present invention relates to the field of real time information systems and, more particularly, to providing predictive results based upon real time data feeds from multiple parties,

### DESCRIPTION OF THE RELATED ART

People and businesses generally make decisions that are associated with various zones of uncertainty. The zones of uncertainty are caused by a decision maker not being aware of one or more key external conditions that affect a decision. Minimizing the zone of uncertainty which minimizes risk of improper decisions, can require a significant amount of data to be rapidly processed and converted into useful information.

One reason that decisions are made within a large zone of uncertainty is that a relative consequence of a poor decision can be low compared to time and effort required to gather data and process it into information. Automated systems can be created which minimize time and effort required to gather data and process the data into information. Thus, automated systems can take a relative cost resulting from uninformed decisions greater than a relative cost of gathering arid processing the data on a per decision basis. Automated systems can be costly to create and maintain, which functions as an entry, barrier for automation.

Information processing problems are magnified when handling real time data. Value potential of real time data can rapidly diminish with time. When real time data is extremely current, it can be used to predict near-term events, thereby minimizing a decision maker's zone of uncertainty. For example, when a news agency indicates a traffic accident has recently occurred, traffic congestion near the accident location can be accurately predicted for a period, such as for a half hour. After that period, it can be presumed that the accident site has been cleared and that normal traffic flow has resumed.

If provided with the accident information in time to select an alternate route, drivers making decisions on travel routes can decrease their travel time by avoiding the accident site. Choices for valid alternate routes decrease as distance to the accident site decreases. For predictive driving decisions, a time for making a driving decision that utilizes the accident information, which is based upon a sum of a data acquisition time, data processing time, information on dissemination time, and decision making time, must total less than a half-hour, after which the accident information is no longer useful to drivers for predictive decision making purposes.

No known conventional system provides information consumers with timely predictive information based upon interpreted real time data from multiple data sources. A preferred system would permit users to define their information needs and would provide information services that satisfy these needs. It would be desirable to minimize the entry barrier for automation and information processing, costs, so as to assure a value of the information services is greater than a risk-attributable cost of making, decisions without the information.

### SUMMARY OF THE INVENTION

The present invention provides a solution for generating predictive results based upon real time data from multiple sources. The system uses a centralized service facility that provides information services to information consumers. The service facility can receive data feeds, which can include static and real time feeds, from multiple data sources. Predictive applications can process data from the feeds to generate predictive results. The predictive applications can be optionally provided by third party development companies. The predictive applications can be tailored for information consumer specific needs. The predictive results can be formatted, summarized, and/or further processed in accordance with a set of business rules established for the information consumer. Information derived from the predictive results can be dispatched to the information consumer in a timely fashion that permits anticipatory decisions to be made based upon the predictive results.

The present invention can be implemented in accordance with numerous aspects consistent with the material presented herein. For example, one aspect of the present invention can include a method for providing a real time information service. The method can receive real time data feeds from remotely located data sources. Data elements from the feeds can be input into at least one predictive application. Predictive results can be generated by the predictive application. An information dispatch can be generated from the predictive results. The dispatch can be conveyed to a remotely located information consumer before events that are indicated by the predictive results occur.

Another aspect of the present invention can include an information service environment which includes a repository, at least one predictive application, and an information service. The repository can receive real time data from remotely located data sources. The predictive application can generate predictive results from the data stored in the repository. The information service can provide remotely located information consumers with real time information based upon the predictive results. The real time information can be customized for each of the information consumers. The real time information can be provided far enough in advance to permit the information consumers to take anticipatory actions based upon the predictive results.

Still another aspect of the present invention can include a system for supplying information services. The system can include multiple data sources and a service facility, which provides at least one information service. The data sources can provide real time data feeds to a repository accessible by the service facility. The service facility can include at least one predictive application. The predictive application can utilize data elements from the data feed,s to generate predictive results. The information service can provide at least one remotely located information consumer with information dispatches based upon the predictive results.

It should be noted that various aspects of the invention can be implemented as a program for controlling computing equipment to implement the functions described herein, or a program for enabling computing equipments to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that provides predictive results based upon real time data feeds from multiple sources.

FIG. 2 presents an example of a predictive system being used by an information consumer in accordance with an embodiment of the inventive arrangements disclosed herein.

FIG. 3 presents an example of a predictive system being used by multiple information consumers in accordance with an embodiment of the inventive arrangements disclosed herein.

FIG. 4 is a flow chart of a method for generating, predictive results from multiple data sources in accordance with an embodiment of the inventive arrangements disclosed herein.

FIG. 5 is a flow chart of a method for converting data from multiple data sources into information for an information consumer in accordance with an embodiment of the inventive arrangements disclosed herein.

FIG. 6 is a flow chart of a method where a service agent can configure a system that provides predictive results in accordance with an embodiment of the inventive arrangements disclosed herein.

### DETAILED DESCRIPTION OF THE INVENTION

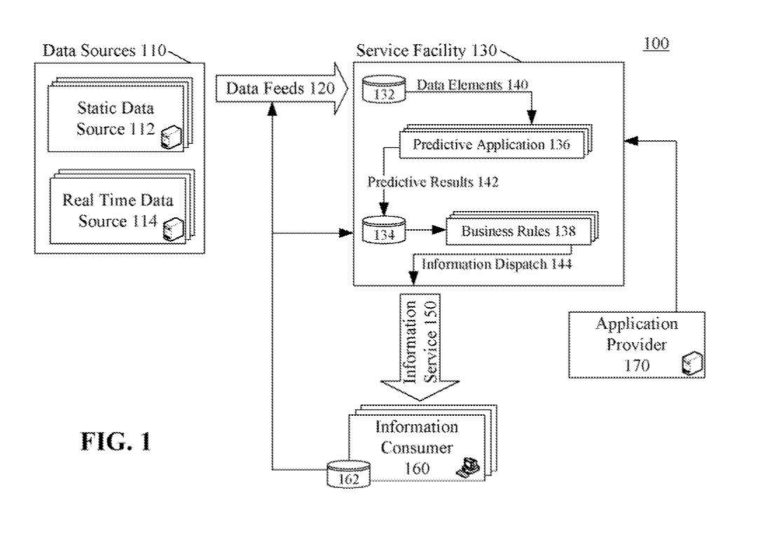

FIG. 1 is a schematic diagram of a system 100 that provides predictive results based upon real time data feeds from multiple sources. In system 100, data sources 110 can provide data feeds 120 to service facility 130. The service facility 130 can interpret data from the feeds 120 to generate information, which is provided to one or more information consumers 160 as part of an information service 150.

The data sources 110 can include one or more static data sources 112 and one or more real time data sources 114. The data feeds 120 can include “pushed” data conveyed from the data sources 110 as well as “pulled” data requested by the service facility 130. In one embodiment one or more external agents (not shown), such as a data synchronization agent, can manage one of more of the data feeds 120. Many different types of software artifacts can be used to establish and maintain the data feeds 120 including, but not limited to, a stand-alone application, a remotely called application, an applet, a servlet, a Web-based application a Web service, and the like.

As used herein, a Web service can be a software component that is implemented in accordance with a collection of platform-independent protocols and standards including, but not limited to, Extensible Markup Language (XML), Simple Object Access Protocol (SOAP), Web Service Description Language (WSDL) and Universal Description, Discovery and Integration (UDDI) standards. Web services can be Uniform Resource Locator (URL) accessible. A Web service can provide a standardized way of integrating Web-based applications executed within a computing environment with remotely located client applications, where the integration typically occurs over an Internet Protocol (IP) backbone.

Data from the feeds can be stored in a repository 132. Predictive applications 136 can pull data elements 140 from the repository, 132 as needed. The predictive applications 136 can process the data elements 140 to generate predictive results 142, which can be stored in repository 134. A set of business rules 138 can further process information in repository 134 to generate different information dispatches 144. The business rules 138 can include user configurable settings (e.g., report settings), program modules, or standalone applications. The information dispatches 144 can be conveyed to one or more information consumers 160, as part of the information service 150.

Predictive applications 136 can include a library of generic applications provided as part of the service facility 130, can include consumer specific applications, and can include one or more third party applications written by application provider 170. In one embodiment, a toolkit can be established for building applications compliant with the service facility 130. The predictive applications 136 can be hosted within service facility 130 or can be remotely executed applications callable from service facility 130. The predictive applications 136 can be implemented in any of a variety of manners including as stand-alone applications as modules executable within a framework of facility 130, remotely executed Web services, and the like.

The information consumer 160 can access the information service 150 using a computing device which includes a repository 162. The repository 162 can also be linked to an information system, which records information for transactions and/or events for which the information dispatch 144 applies. For example if the information dispatch 144 helps anticipate invention needs, then the repository 162 can include inventory and sales data. In one embodiment, a feedback loop can be established using the repository 162 to optimize settings of the service facility 130 for the consumer 160.

For example, repository 162 data can be provided as one of the data feeds 120. Repository 162 data can also be used to directly adjust business rules 138. For example, anticipatory actions which are appropriate based upon predictive results 142 can be based in part or optimized by repository 162 data.

Repositories 132, 134, and 162 can be a physical or virtual storage spaces configured to store digital content. Each of the repositories 132, 134, and 162 can be physically implemented within any type of hardware including, but not limited to, a magnetic disk an optical disk, a semiconductor memory, a digitally encoded plastic memory, a holographic memory, or may other recording medium. Further, each repository 132, 134, and 162 can be a stand-alone storage unit as well as a storage unit formed from a plurality of physical devices. Additionally, content can be stored within repositories 132, 134 and 162 in a variety of manners. For example, content can be stored within a relational database structure or can be stored within one or more files of a file storage system, where each file may or may not be indexed for information searching purposes. Further, the repositories 132, 134, and 162 can utilize one or more encryption mechanisms to protect stored content from unauthorized access.

The data sources 110 service facility 130, information consumer 160, and the application provider 170 can be communicatively linked via one or more networks (not shown). The networks can include any hardware/software and firmware necessary to convey digital content encoded within carrier waves. Content can be contained within analog or digital signals and conveyed through data or voice channels. The networks can include local components and data pathways necessary for communications to be exchanged among computing device components and between integrated device components and peripheral devices. The networks can also include network equipment, such as routers, data lines, hubs, and intermediary servers which together form a packet-based network, such as the Internet or an intranet. The networks can further include circuit-based communication components and mobile communication components, such as telephony switches, modems, cellular communication towers, and the like. The networks can include line based and/or wireless communication path ways.

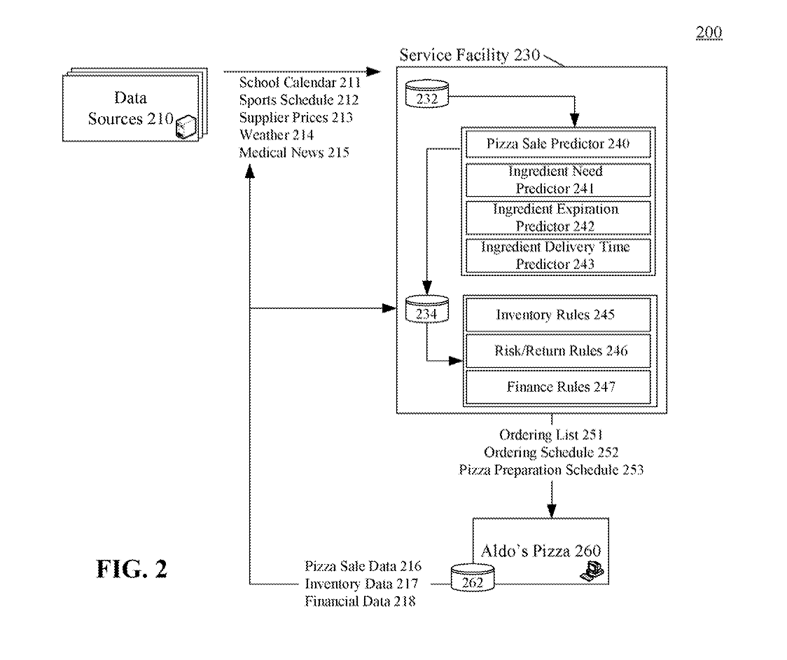

FIG. 2 presents an example of a predictive system 200 being used by an information consumer 260 in accordance with an embodiment of the inventive arrangements disclosed herein. This example represents one of many contemplated scenarios in which components of system 100 apply.

In system 200, the information consumer is Aldo's Pizza 260. For purposes of our example, Aldo has been operating his family owned and operated pizza business for years, servicing the local population of suburban Bellpark. Takeout and delivery are his mainstay. Now losing business to fast food pizza companies, such as DOMINOS and PIZZA HUT, moving in on his turf, Aldo needs to gain efficiencies in his operations. He knows he has better quality, product but his product is more expensive because he does not have the economies of scale of the larger chains. He thinks he can beat the competition if he can get his prices down. But, to do so, he has to lower costs.

By buying in large quantities, Aldo can take advantage of the tiered pricing of his dough, sauce, cheese, and toppings providers. But, he would have to sell in larger quantities, too. Otherwise, be would wind up with too much waste from spoilage to realize any significant gain. Aldo knows he can run specials and that will increase demand somewhat but it is neither sustainable nor predictable. Day in and day out, Aldo watches his customers more and more looking for patterns. He observes that weekends are slow; certain evenings are busier than others; spring, fall, and winter are busier than summers; holidays are slow. Then, he notices that busy evenings are also accompanied by more sand and dirt left in the pathway to his counter by little kids in varying-by-the-season baseball, soccer, and basketball uniforms, brought into the store by their parents for takeout pizzas.

Aldo reasons that busy, parents buy more pizza when pressed for time due to pressures of jobs, school, and kids' leagues. Everyone is hungry after practice sessions and games but have no time for cooking,. Aldo decides that if he can time his purchasing, production, and sales to the school and league schedules, he will gain the efficiencies he needs to tower prices and increase his sales.

Hence, Aldo wants to predict pizza demand based upon local sporting events, for which Aldo creates (or obtains) the pizza sale predictor application 240. A complex relationship can exist, however, between needed pizza ingredients and pizza sales, which can be resolved with an ingredient need predictor application 241. Further, different ingredients expire at different times depending on weather, ingredient freshness, and so on, so Aldo uses an ingredient expiration predictor application 242 to handle these variables. Finally Aldo receives his ingredients from various suppliers during their normal delivery schedule, which causes a delay between times Aldo orders ingredients and when he receives them, for which the ingredient delivery time predictor application 243 is created.

It should be understood that each of these applications 240-243 can interoperate. Further, the applications 240-243 need not be implemented individually, but can be implemented as a single integrated predictive application. Modularizing predictive applications, however, can facilitate predictive application reuse or use by other information consumers, who are in situations somewhat similar to Aldo's situation. In general, the system 200 uses an architecture designed to be scalable, where multiple information consumers can share data feeds, predictive applications, report formats, and the like.

Once the applications 240-243 are created, Aldo can upload the applications into service facility 220. Aldo can also customize his information service by setting rules for his inventory 245, setting risk/return rules 246, and by setting finance rules 247, each of which can have an appreciable effect on predictive results and optimal system 200 states.

For example, it may be financially optimal to purchase pizza boxes in quantities of ten thousand, but the inventory rules 245 can specify that Aldo only has space for storing up to two thousand pizza boxes. Similarly, Aldo can set his risk/return parameters 246 to be aggressive, which can maximize potential profit. The financial rules 247 can establish a total amount of available cash that Aldo has to purchase ingredients.

Next, Aldo links various data sources 210 to the service facility 230, where the data sources 210 provide data feeds necessary for driving applications 240-243. Different data feeds can includes a school calendar feed 211, a sports schedule feed 212, supplier prices feed 213 and the like. Each feed 211-213 can be obtained from separate data sources 210. When feed data changes, such as sporting events being canceled, updates can be obtained in real time.

Data from the data feeds can be stored in repository 232 and processed by applications 240-243, which generate predictive results that are placed in repository 234. Further processing can be performed in accordance with rules 245-247 to generate ordering list 251, ordering schedule 252 and pizza preparation schedule 253. Aldo's Pizza 260 can use the ordering list 251 and schedules 252 and 253 to take anticipatory actions based upon the predictive results.

For example, the ordering list 251 and ordering schedule 252 can specify when Aldo should order ingredients to ensure that sufficient ingredients are at hand to satisfy predicted needs. The pizza preparation schedule 253 can assist Aldo in anticipating orders to improve delivery preparation and response time.

Initial trials of the pizza predication information service can yield positive results. Aldo, however, can notice that the system 200 doesn't work particularly well on rainy days or in flu season. Aldo concludes that when practices and games are canceled because of rain, and when attendance trails off because of illness, anticipated pizza demand decreases. Aldo can modify the predictive applications 240-243 to utilize a weather feed 214 and/or a medical news feed 215 to adjust for these events.

In addition to new external factors that effect predictive results of system 200, historical sales data stored in repository 262 can be used to optimize the system 200. For example, pizza sale data feed 216, ingredient inventory data feed 217, and financial data feed 218 can be used by an optimization engine (not shown) of facility 230 to automatically and dynamically refine parameters and increase performance of the system 200.

It should be appreciated that the predictive applications 240-243 established for Aldo's Pizza 260 can be valuable for any similarly situated business. Assuming that Aldo developed, or had a computer expert develop, the predictive applications 240-243 which are refined and trained over time, Aldo can potentially resell or license his predictive applications 240-243 to other pizza establishments. Additionally, cooperative agreements can be established with service facility 230, where Aldo can permit the service facility 230 to provide information services, which are based upon Aldo's predictive applications 240-243, to other pizza establishments for an agreed upon usage fee.

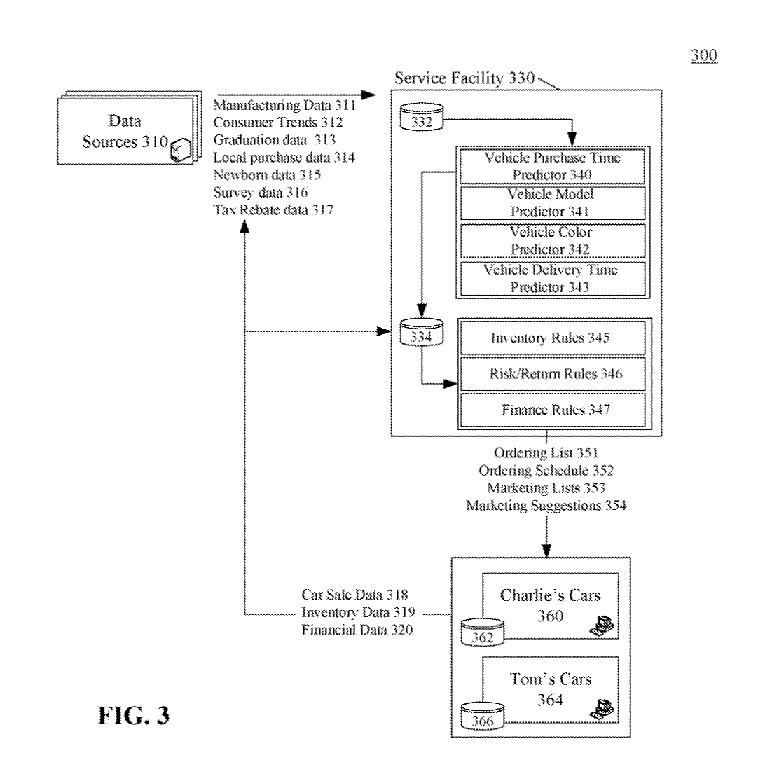

FIG. 3 presents an example of a predictive system 300 being used by multiple information consumers 360 and 364 in accordance with an embodiment of the inventive arrangements disclosed herein. This example represents one of many contemplated scenarios in which components of system 100 apply.

In system 300, Charlie's Cars 360 is an initial information consumer. A marketing strategist for Charlie's cars 360 is tasked with figuring out how to sell more cars for greater profits. The marketing strategist desires a new sustainable model for optimizing the production/delivery/sales cycle. In shifting through historical sales data, the marketing strategist notices that there are certain events in people's lives that are tied to car buying, such as graduations, anniversaries, newborns, and tax rebates.

There is also a correlation between these events and sales of different car models and car colors. For example, increases in van and SUV sales generally correspond with newborn babies. Increases in luxury car sales are associated with anniversaries. Increases in economy car sales are associated with graduations. Increases in expensive sports car sales are associated with received tax rebates. Further, more conservative colors are associated with newborn related events, where trendier colors are associated with graduation events.

Using all of tis information, the marketing strategist develops a vehicle purchase time predictor application 340, a vehicle model predictor application 341, and a vehicle color predictor application 342. These applications 340-342 can utilize data feeds established for consumer trend data 312, graduation data 313, local purchase data 314, newborn data 315, and tax rebate data 317. Additionally a vehicle delivery time predictor application 343 can use manufacturing data feeds 311 to determine delay times between orders and arrivals. Finally, inventory mules 345, risk/return rules 346, and financial rule 347 for Charlie's Cars 360 can be specified with the service facility 330.

Using this information, system 300 can place data from flows 311-317 into repository 332, which is used to drive applications 340-343. Predictive results from the applications 340-343 can be stored in repository 334, which can be further processed in accordance with rules 345-347 to repetitively generate ordering list 351, ordering schedule 352, marketing lists 353, and marketing suggestions 354.

Charlie's Cars 360 can order flew cars in accordance with ordering lists 351 and schedule 352, which will ensure cars will be available to satisfy a predicted customer need. Marketing suggestions 354 can also be provided that target different promotions to appeal to different car buying groups at times when it is likely that the targeted groups are considering buying a vehicle. A marketing list 353 can also be generated, which provides information for a set of buyers, expected buyer preference, and the like, which can be used for direct marketing campaigns.

Over time, the marketing executive uses customer surveys (survey data feed 316) and local purchasing data 314 to increase the predictive effectiveness of the system 300. Additionally, MIS data from repository 362, such as car sale data 318, inventory data 319, and financial data 320, can be used to optimize applications 340-343 and rules 345-347.

The marketing efforts based upon the predictive information service for Charlie's Cars 360 can result in increased revenue, which is noticed by Tom, owner of Tom's Cars 364. Tom's Cars 364 can be located in a retirement community thirty miles away from Charlie's Cars 360, which is located near a university heaving a younger population. Historical sales data 366 for Tom's Cars 364 suggests that people in the retirement community, are not making their buying decisions based on having babies and color. Instead, retirees base their decisions on how long ago they bought their last car, seating comfort, and large trunks to carry golf bags.

Consequently, setting specific to Tom's Cars 364 can be established for vehicle purchase time predictor application 340, vehicle model predictor application 341, and vehicle color predictor application 342. Vehicle delivery time predictor application 343 can remain unchanged. Different rules 345-347 can also be established that are specific to Tom's Cars 364. Tom's Cars 364 can receive the same general inventory service artifacts, such as list 351, schedule 352, lists 353, and suggestions 354 as those received by Charlie's Cars 360. In information consumer specific optimizations based upon repository 366 data can be performed for Tom's Cars 364.

System 300 can be configured so that Charlie's Cars 360 and Tom's Cars 364 share data feeds 311-317 and/or predictive applications 340-343 when appropriate in one embodiment, each information consumer (360 and 364) can selectively opt to use different feeds 311-317 or data sources 310 for the feeds, which can result in different predictive results, even if the same applications 340-343 and rules 345-347 are used. For instance, local purchase data 314 which differs greatly between the two car businesses can dominate the predictive results. Sharing data feeds 311-317 and predictive applications 340-343 can help multiple information consumers 360-364 share maintenance and/or development costs.

System 300 is a highly scalable system capable of servicing information needs for a large volume of information consumers from a single centralized service facility 330. In various embodiments, components of the service facility 330 can be implemented in a clustered arrangement to permit resilient operations and to perform load balancing functions. Additional optimization components (not shown) can distribute functions of service facility 330 to network points close to different clusters of users to minimize latencies when dealing with time critical data and information flows. Further autonomic techniques (not shown) can be implemented for system 300 to permit components of the system 300 to self-adjust and/or to self-correct as necessary.

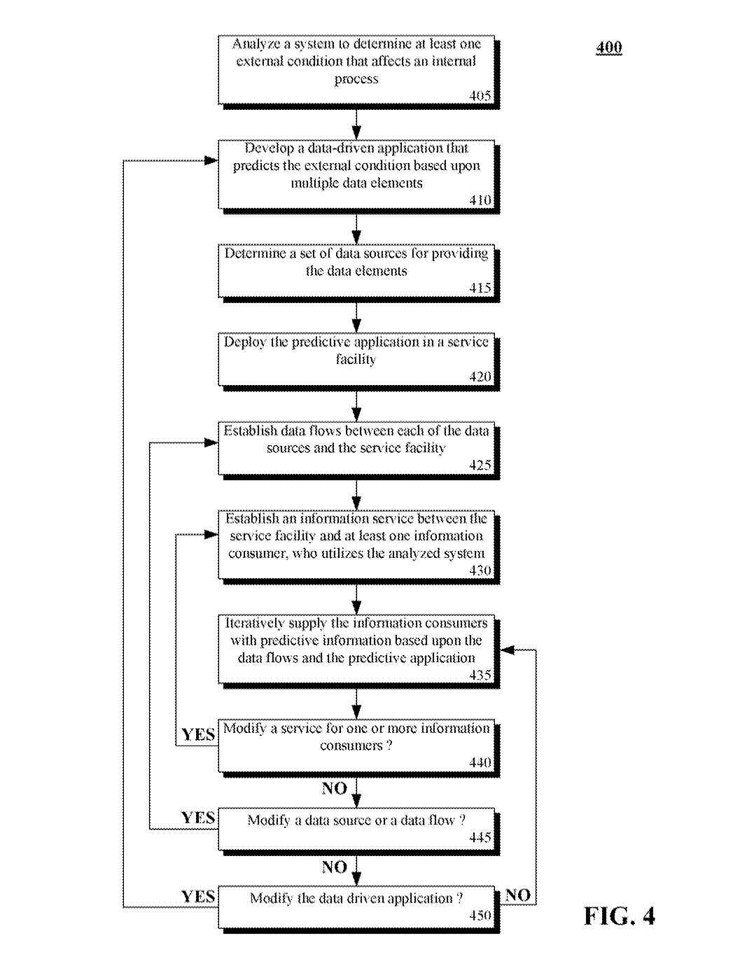

FIG. 4 is a flow chart of a method 400 for generating predictive results from multiple data sources in accordance with an embodiment of the inventive arrangements disclosed herein. Method 400 can be performed in the context of a system 100 or in the context of any system that provides information services to information consumers.

Method 400 can begin in step 405, where a decision system can be analyzed to determine at least one external condition that affects an internal process of the decision system. In step 410, a data driven application can be developed that predicts one or more of tie external conditions based upon one or more data elements. For example, the data driven application, referred to as a predictive application, can determine a quick travel route between two points, where the quick travel route can be based upon distance, available roadways, weather conditions, traffic congestion, traffic light sequencing data, and other data elements in step 415, a set of data sources can be determined for providing the data elements. For example, an online weather service can be used to provide weather condition data and a mapping Web site can be used to provide roadway maps for the aforementioned predicative application.

In step 420, the predictive application can be deployed in a centrally located service facility. In step 425, data flows can be established between the data sources and the service facility. The data flows can be continuous and real time flows. In one embodiment, one or more of the data flows can be provided via a Web service. In step 430, an information service can be established between an information consumer and the service facility. The information consumer can be a participant in the decision system which uses the predictive application. In step 435, the information service can iteratively supply information consumers with predictive information which is based upon data flows and the predictive application.

In one embodiment, the information service can be provided as a Web service. The information service can also provide real time information feeds to a consumer or a computing system performing anticipatory actions for the consumer based upon the predictive information. The invention is not limited in this regard, however, and the information service can be provided in any manner in which the information consumer is presented with predictive information in a timely fashion. A definition for a timely fashion can vary on a case-by-case basis depending on details of the decision system and the data flows.

In step 440, an information service can be selectively modified for one or more information consumers. For example, a new information consumer can subscribe to an existing information service or an existing consumer can unsubscribe to a service. When the service is modified, the service facility can be contacted and the information consumer can be added/removed from a set of consumers of the information service as appropriate, which is shown by the method looping from step 440 to step 430.

In step 445, modifications can be selectively made to a data source or a data flow. For example, an existing data source can be replaced with a substitute data source, which provides more accurate data, more rapidly updates the data, provides data for a lesser fee, or provides some other advantage over the original data source. When the data source is to be updated, new data source specifying details can be provided, and the new data source can be linked to the service facility, which is shown by the method looping from step 445 to step 425.

In step 450, a predictive application can be selectively modified. If no modification is made, the method can loop to step 435, where data can continue to be received, processed, and turned into predictive information, which is supplied to information consumers. If a predictive application is to be modified, the modifications to an existing application can be made and applied or a new predictive application can be developed and deployed, which is shown by the method looping from step 450 to step 410.

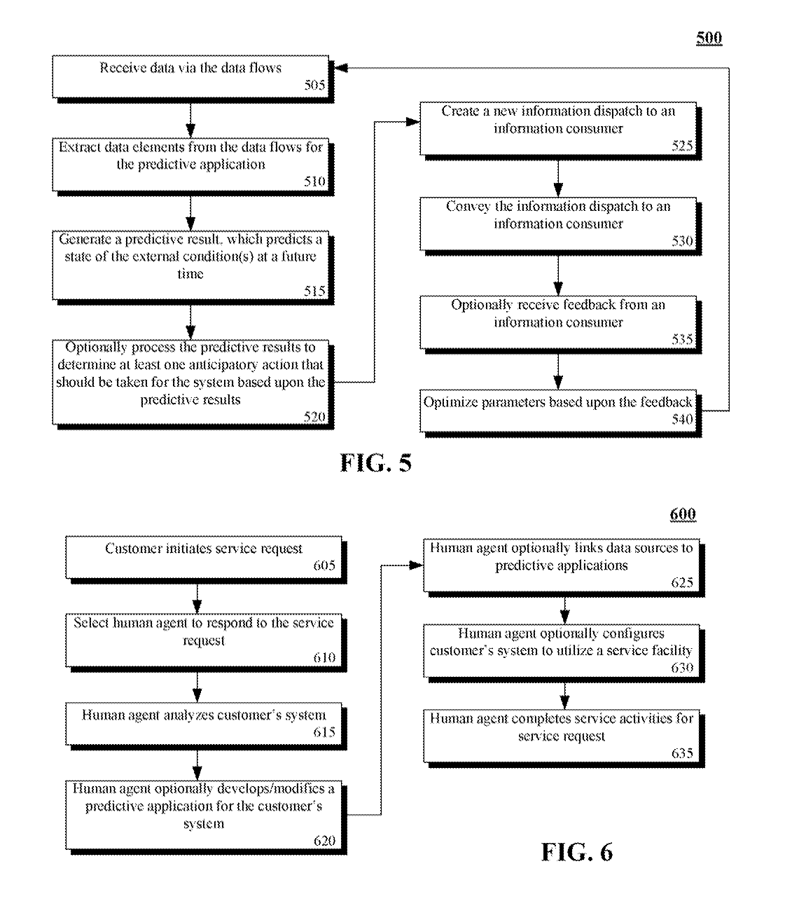

FIG. 5 is a flow chart of a method 500 for converting data from multiple data sources into information for an information consumer in accordance with an embodiment of the inventive arrangements disclosed herein. Method 500 can be performed in the context of system 100. Method 500 can be one implementation for iteratively supplying information consumers with predictive information as indicated in step 435 of method 400.

Method 500 can begin in step 505, where data is received through one or more data flows. In step 510, data elements can be extracted from the data flows. This extraction can convert the data elements from an original format used by an associated data source to a format understood by a predictive application. In step 515, the predictive application can generate a predictive result. The predictive result can predict a future state of one to more conditions external to a decision system. In step 520, the predictive results can be optionally processed to automatically determine at least one anticipatory action. In step 525, a new information dispatch can be created. The dispatch can include the predictive results, a report based upon the predictive results, and/or one or more suggested anticipatory actions to take in light of the predictive results.

In step 530, the information dispatch can be conveyed to one or more information consumers. In step 535 feedback can be optionally received from the information consumer. In step 540 parameters of the predictive algorithm and/or a service facility can be optimized based upon the feedback. The method can loop from step 540 to step 505, where additional data can be received.

It should be appreciated that although method 500 is shown as a series of sequential steps, these steps can occur asynchronously. For example, different data sources can be constantly providing different data to the information service facility at different times. The predictive application, which may need data from multiple ones of these sources can execute in a cyclic fashion. Additional events can be tied to received data values, which indicate an urgency that can cause out-of-cycle executions of the predictive application. For instance, data relating to a car accident can trigger an immediate re-execution of a predictive application associated with driving travel routes. Similarly, information dispatches can occur asynchronously to runs of the predictive applications, with particularly important or unexpected predictive results forcing an immediate information dispatch. Data inputs and/or information outputs can be (obtained and/or provided in real time.

FIG. 6 is a flow chart of a method 600 where a service agent can configure a system that provides predictive results in accordance with an embodiment of the inventive arrangements disclosed herein. Method 600 can be preformed in the context of system 100 or a method 400.

Method 600 can begin in step 605, when a customer initiates a service request. The service request can be a request for a service agent to set up a predictive results system, to configure a predictive results system for a particular customer, to troubleshoot a predictive results system, to train personnel to use a predictive results system, and/or to create new predictive applications for a predictive results system. In step 610, a human agent can be selected to respond to the service request. In step 615, the human agent can analyze a customer's current system and information needs and can develop a solution.

In step 62, the human agent can optionally develop or modify a predictive application in accordance with the customer's information needs. These predictive applications can be placed in a centralized service facility, which provides information services for the customer. In step 625, the human agent can optionally link one or more data sources to the service facility. The data sources can continuously provide data including real time data, to the service facility. This data can be used to drive the predictive applications in step 630, the human agent can optionally configure the customers system to utilize information provided by the service facility. For example, a customer's inventory ordering system can be configured to accept information feeds from the service facility and to take programmatic actions based upon these feeds. In step 635, the human agent can complete the service activities.

It should be noted that while the human agent may physically travel to a location local to adjust the customer's computer or application server, physical travel may be unnecessary. For example, the human agent can use a remote software agent to remotely manipulate the customer's computer system.

The present invention may be realized in hardware, software or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being, loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notations of a set of instructions intended to cause a system having an information processing capability, to perform a particular function either directly or after either both of the following: a) conversion to another language, code or notation; b) reproduction in a different material form.

What is claimed is:

1. A method for providing an information service comprising:
receiving real time data feeds from a plurality of remotely located data sources;
inputting data elements from the data feeds into at least one predictive application;
the predictive application generating predictive results; and
conveying an information dispatch based upon the predictive results to a remotely located information consumer before events that are indicated by the predictive results occur.

2. The method of claim 1, wherein the information dispatch is provided as part of an information service wherein said information service continuously provides the information consumer with information dispatches as data from the real time data feeds changes.

3. The method of claim 1, wherein the information service provides real time information that is dynamically generated from a combination of real time data feeds and static data feeds.

4. The method of claim 1 wherein the information service is a Web service.

5. The method of claim 1 wherein the information dispatch and the predictive application are customized for the information consumer.

6. The method of claim 1, wherein the information dispatch specifies at least one anticipatory action, which the information consumer is to take in anticipation of the predictive results.

7. The method of claim 1, wherein the receiving, inputting, generating, and conveying steps are performed by a service facility, which is a network accessible computing environment that hosts a plurality of predictive applications used by a plurality of remotely located information consumers.

8. The method of claim 7, wherein said at least one predictive application is uploaded into the service facility, by, a third party application provider.

9. The method of claim 1, wherein said steps of claim 1 are steps performed by at least one machine in accordance with at least one computer program having a plurality of code sections that are executable by the at least one machine.

10. The method of claim 1, wherein said steps of claim 1 are steps performed by at least one of a service agent and a computing, device manipulated by the service agent, the steps being performed in response to a service request.

11. An information service environment comprising:
a repository for receiving real time data from a plurality of remotely located data sources;
at least one predictive application for generating predictive results based upon data in the repository; and
an information service for providing remotely located information consumers with real time information based upon the predictive results, wherein the real time information is customized for each of the information consumers, and wherein the real time information is provided far enough in advance to permit the information consumers to take anticipatory actions based upon the predictive results.

12. A system for supplying information services comprising;
a plurality, of data sources for providing real time data feeds to a repository, of a remotely located service facility;
the service facility comprising at least one predictive application, wherein the predictive application utilizes data elements from the data feeds to generate predictive results; and
an information service configured to provide at least one remotely located information consumer with information dispatches based upon the predictive results.

13. The system of claim 12, wherein the information dispatches specify at least one anticipatory actions which the information consumer is to take in anticipation of the predictive results.

14. The system of claim 12 wherein the information consumer receives the information dispatch before events that are indicated by the predictive results occur.

15. The system of claim 12, wherein said at least one information consumer comprises a plurality of information considers and wherein the information dispatches and the predictive application are customized for each of the information consumers.

16. The system of claim 12, herein at least one system application is implemented as a Web service, wherein said system application comprises at least one application selected from a group of applications consisting of an application that provides the information service, an application that handles one of the data feeds, and the predictive application.

17. The system of claim 12, further comprising:
business rules for processing the predictive results in a manner specific to said information consumer.

18. The system of claim 17, wherein the information consumer provides data associated with the information dispatches, which is indicative of a success of the predictive results, wherein said consumer provided data is used by, the service facility to optimize at least one of the predictive application and the business rules.

19. The system of claim 12, wherein said at least one information consumer comprises a plurality of information consumers, each of which subscribes to said information service, wherein the information dispatches include different customized information specifically tailored for each of the different information consumers.

20. The system of claim 12, wherein said data sources comprise at least one static data source providing a static data feed to the repository, wherein the predictive application utilizes data elements from said static data feed and from said plurality of real time data feeds.

21. The system of claim 12, wherein the predictive application is constructed using an application design toolkit configured specifically for the service facility.

22. The system of claim 12, wherein the information consumer sells a product to purchasers, wherein the predictive application predicts future purchaser demand, and wherein the information dispatch includes a list of order dates necessary to order items to ensure ordered items are available for sale to meet the predicted purchaser demand.
